(19) United States
(12) Patent Application Publication
(10) Pub. No.: US 2003/0066055 A1
(43) Pub. Date: Apr. 3, 2003

(54) Profiling computer programs

(76) Inventor: John Michael Spivey, Oxford (GB)

Correspondence Address: NIXON & VANDERHYE P.C., 8th Floor, 1100 North Glebe Road, Arlington, VA, 22201, US

(21) Appl. No.: 10/132,734

(22) Filed: Apr. 26, 2002

Related U.S. Application Data
(60) Provisional application No. 60/286,358, filed on Apr. 26, 2001.

(51) Int. Cl. G06F 9/44

(52) U.S. Cl. 717/131

(57) ABSTRACT

A call-graph profile is created by constructing a finite state machine during execution of a program to be analyzed. Each state in the state machine corresponds to an execution context, ie. the set of subroutines that are active in the program at a particular time, together with information about the subroutines that precede and follow their most recent activation on the program's stack. Each transition between states represents a change in execution context taking place on a subroutine call. Each state is represented by a dynamically-allocated record containing a counter that stores the number of times the state has been entered, a counter storing the number of self-transitions made from the state to itself, a timer that stores the total time spent in the state, and data that records the set of subroutines that are active in the execution context. Transitions between states are stored in a hash table whose key is a pair of addresses: the address of the record representing the current state and entry address of the subroutine being called. The profiler also maintains a shadow stack which shadows the subroutine stack of the running program. Each item in the shadow stack is a state of the finite state machine represented by a pointer to the current state record. On entry to a subroutine a new item is added to the stack, and on a return, the stack is popped. After execution the data for each state is written to a file and is then analyzed to produce a report for each subroutine giving the time spent in each routine and in its descendents.

The present invention is concerned with profiling which is a technique for analysing the run-time performance of computer programs. It is particularly concerned with a method of profiling which is capable of recording quickly and accurately more information about the time spent in executing different parts of a computer program.

Profiling is a widely-used family of techniques for analysing the run-time performance of computer programs. It entails measuring the time spent executing each part of the program, such as each subroutine, so that effort at improving the speed of the program can be directed to those parts where improvements will have the greatest effect on the time taken on the program overall. Data about the time spent in executing each part of the program is collected during execution of the program being profiled and after execution the data is analysed to produce a report which shows how much time is used by each part of the program. Most commonly, each subroutine is taken as a single part of the program for timing purposes, so that profiling gives the total time spent in executing each subroutine of the program. A “flat profile” just records the time spent in each subroutine. A “call-graph profile” records not only the time, but also the paths through the subroutines, and it also charges the time taken by a subroutine to the routines that called it. This produces for each subroutine the time for the total time taken by that routine and by those that it called.

A commonly used tool for call-graph profiling is gprof, a piece of software covered by the GNU public licence.

The following entry is typical of the data produced by gprof. It concerns a routine called Lookup that is ninth in rank order of total execution time.

| Index | Total | Self | Children | Calls | Name |
|---|---|---|---|---|---|
| | | 1.40 | 9.40 | 194/196 | AddRoad [7] |
| | | 0.00 | 0.10 | 2/196 | Search [10] |
| [9] | 10.9% | 1.40 | 9.50 | 196 | Lookup [9] |
| | | 9.30 | 0.00 | 196/246 | Hash [8] |
| | | 0.20 | 0.00 | 227/484 | COMPARE [22] |

This table shows that Lookup, together with the subroutines Hash and COMPARE that it calls, accounts for 10.90 seconds of the program's total execution time. 1.40 seconds spent running Lookup itself, and 9.50 seconds spent running those two routines. Lookup is called by AddRoad 194 times and by Search 2 times, and Lookup and its children contribute the times shown to the total runtime of its callers.

However, gprof suffers from the weakness that it does not properly link the timing data collected during execution with data about which routines call which others. This leads to two forms of inaccuracy in the report produced:

1. The time taken by each subroutine is distributed among it callers in proportion to the number of times each of them called the subroutine. This is accurate only when the subroutine takes the same time on each occasion that it is called, or at least when the average time taken by the subroutine for each caller is independent of the identity of the caller. This condition is called the average time assumption. For many programs, the average time assumption is inaccurate. This may be because the time taken by a subroutine depends on its parameters, and the parameters are drawn from different distributions in different textual calls of the subroutine. In object-orientated programs (where the methods belonging to each class may be regarded as subroutines) and higher-order functional programs, this variation is likely to be particularly great, because parts of the task performed by a subroutine are specified by its arguments and will differ from call to call.

2. Recursion occurs when a call to a subroutine leads to another call to the same subroutine that begins before the first call has ended. In direct recursion, the subroutine calls itself. In indirect or mutual recursion, a group of two or more subroutines contain calls to each other, in such a way that a call from a first routine to a second can lead to the second routine calling the first routine, possibly via one or more others. Mutual recursion presents an insuperable problem for gprof, because the data collected during execution is insufficient to divide the time taken by a mutually-recursive group of subroutines among them accurately. Just as with the average time assumption, this restriction becomes more troublesome when the program being analysed uses object-orientated or functional programming.

One way of overcoming the problems of gprof would be to record the entire state of the program's subroutine stack at each entry to or exit from a subroutine. However, this imposes a very large overhead on the execution of the program being analysed, so that the program typically runs many times more slowly during profiling than it would without profiling. This actually causes two problems itself:

1. By slowing the program down, the overhead of profiling may reduce the size of the input that can feasibly be processed during profiling, so reducing the usefulness of the data collected.

2. Because it interferes with the normal operation of the program, the profiling activity may distort the timings that it is trying to measure. This is particularly true on modem computers whose good performance depends on memory caches, because profiling activity may significantly disturb the patterns of access to memory of the program being analysed. The overhead on execution time due to profiling gives a good indication of the degree of disturbance being caused.

It is an object of the present invention to provide a profiling method and profiler which overcomes the problems mentioned above. The invention provides a profiler and method of profiling which allow accurate profiling data to be gathered with a reasonable overhead. The data which is gathered is sufficient to make an accurate attribution of time spent in each routine to its ancestors in the call-graph, even in the presence of direct or indirect recursion in the program being analysed.

Thus the present invention provides a method of profiling the execution of a computer program comprising subroutines, the method comprising recording the identity of each called subroutine, its execution time and wherein execution context is recorded in the states of a finite state machine.

A finite state machine is a computer consisting of a set of states (that usually store something), an initial state, an input alphabet, and a transition function which maps input symbols of the input alphabet and the current state to a new state. A finite state machine has a limited number of possible states.

With the present invention the finite state machine is preferably constructed during execution of the computer program being profiled and each state in the state machine may correspond to a set of execution contexts for the program. The execution context may be the sequence of subroutine activations, from the oldest to the most recent, that are present in a running program. This execution context is represented in a running program by the contents of the subroutine stack.

Thus with the present invention, each transition between states of the finite state machine represents a change in the execution context that takes place on a subroutine call.

The finite state machine may record the execution context by recording the identity of each of the set of active subroutines preceding the currently active subroutine in the call-graph. Further, each state may record the identity of the currently active subroutine and its cumulative execution time.

Each state may also record the number of entries to that state, and also the number of directly recursive calls from that state, ie. where the currently active subroutine calls itself.

In order to reduce the amount of data stored, the execution context may record only the most recent invocation of each subroutine. Thus when a new subroutine is called, earlier invocations of that subroutine are removed from the recorded execution context.

Alternatively, each state may record the most recent activation of each currently active subroutine, together with the outgoing arc by which it has called another subroutine. This information may be economically represented by storing the list of most recent activations and ensuring that each is followed in the list by a record of the subroutine it has called. If this following activation would otherwise be dropped from the list because it is not the most recent activation of the relevant subroutine, then it is retained for this purpose and marked specially. In the preferred embodiment, subroutines are represented by their entry addresses, and if these addresses do not occupy all available bits in the machine word, then the mark may conveniently be represented using one of the spare bits, either at the most-significant end of the word or (if subroutines are aligned in memory) at the least-significant end.

Optionally, further marked activations may be added to the list of activations so that the arc incoming to each unmarked activation is recorded as well as the arc outgoing from it.

Whatever list of marked and unmarked activations is stored in the representation of a state, the method may further comprise comparing the activation list of each new state with the activation list of other states already existing that have the same currently active subroutine. Where an existing state exists that has the same activation list as a desired state, a transition may be recorded from the current state to this existing state, and creation of another new state may be avoided. This reduces the number of different states of the finite state machine in a program that exhibits mutual recursion.

The transition function of the finite state machine may be embodied by a hash table recording transitions between states, and a set of state records, recording the data for each state. Transitions are recorded in the hash table by making the key of the hash table consist of the address of the record representing the current state, together with the entry address of subroutine being called. Thus hashing those two addresses gives a location in the hash table, which indicates the new state resulting from the transition. This data structure makes it possible to compute the result of any state transition very quickly.

A shadow stack may also be maintained which shadows the subroutine stack of the running program. Each item in the shadow stack is a state of the finite state machine, represented by a pointer to the relevant state record. On entry to a subroutine, a new item is added to the shadow stack by following the state transition in the state machine from the existing state to the new state. The address of the new state is placed on top of the stack. On a return from a subroutine, the stack is popped, which returns to the configuration it had before the call.

It will be appreciated that the method is computer implemented as a computer program. The computer program may be provided on a storage medium and the invention extends to such a computer readable storage medium. The invention also extends to a computer system programmed to implement the method steps. The invention therefore also provides a profiler, an apparatus for profiling a computer program for carrying out the above method.

The invention will be further described by way of example, with reference to the accompanying drawings, in which:

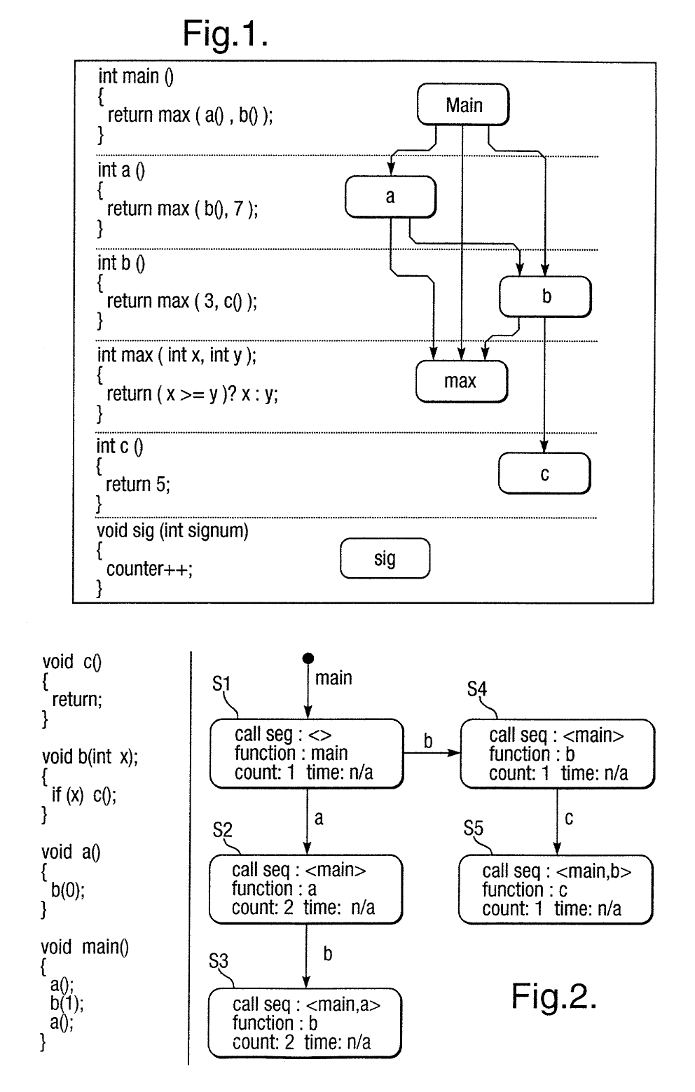

FIG. 1 illustrates a simple program and its call-graph;

FIG. 2 illustrates a program with its corresponding finite state machine (also referred to as state machine);

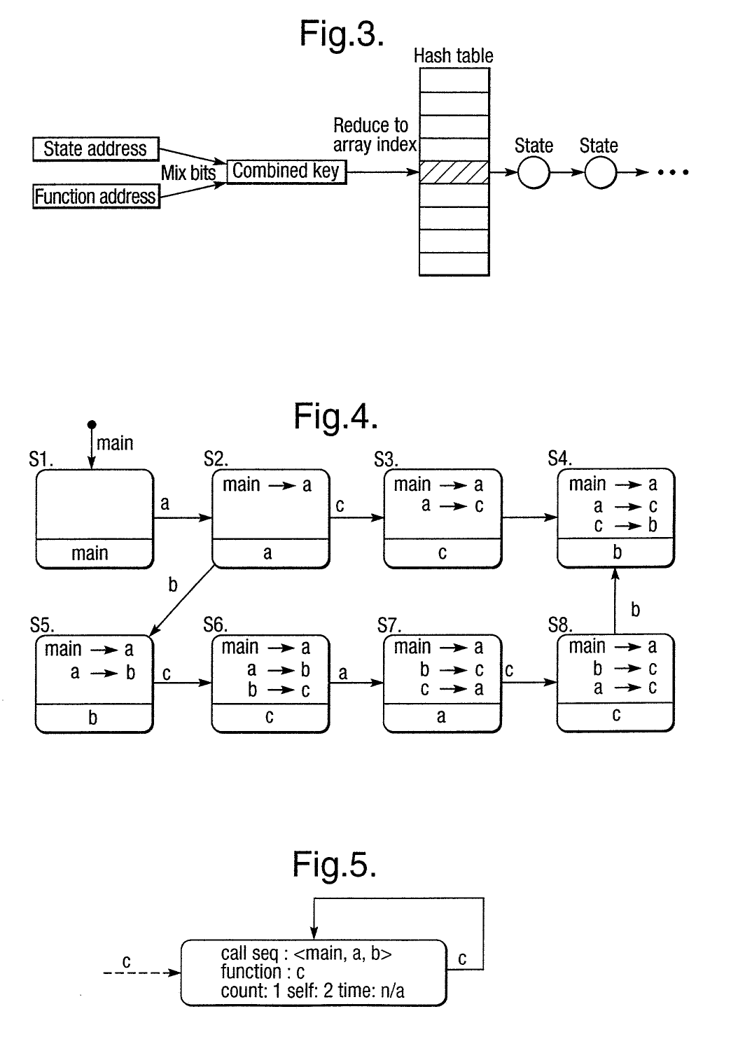

FIG. 3 illustrates access to the hash table recording transitions in an embodiment of the invention;

FIG. 4 illustrates a finite state machine in another embodiment of the invention;

FIG. 5 illustrates direct-recursion;

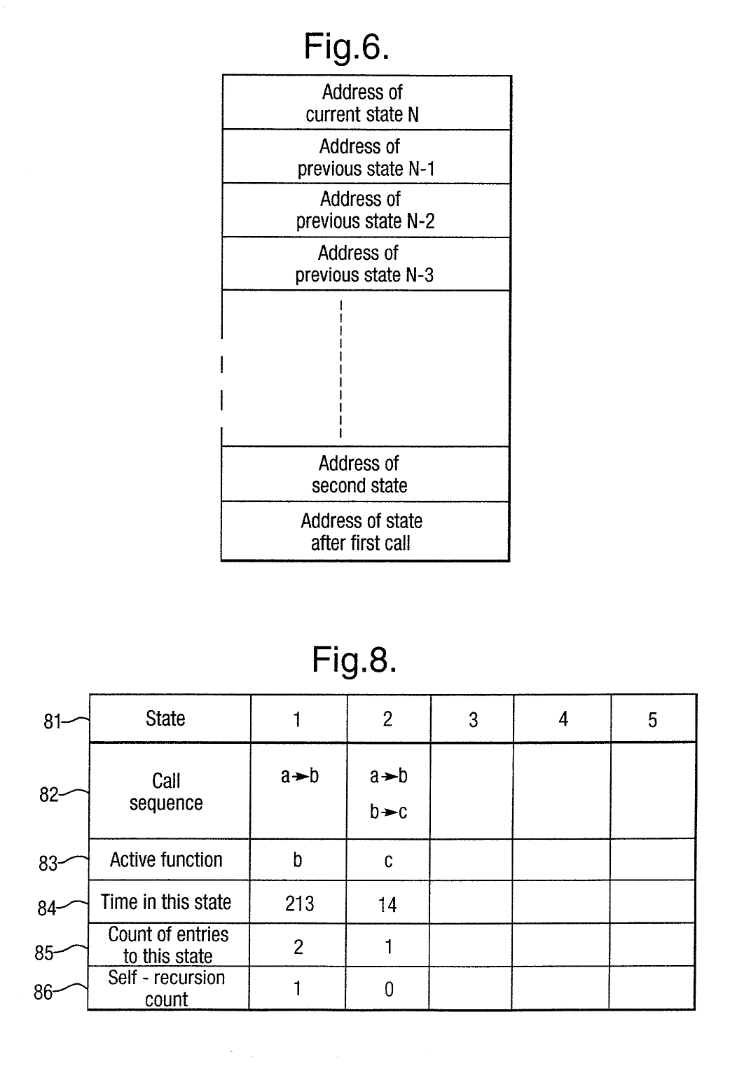

FIG. 6 illustrates the shadow stack of one embodiment of the invention;

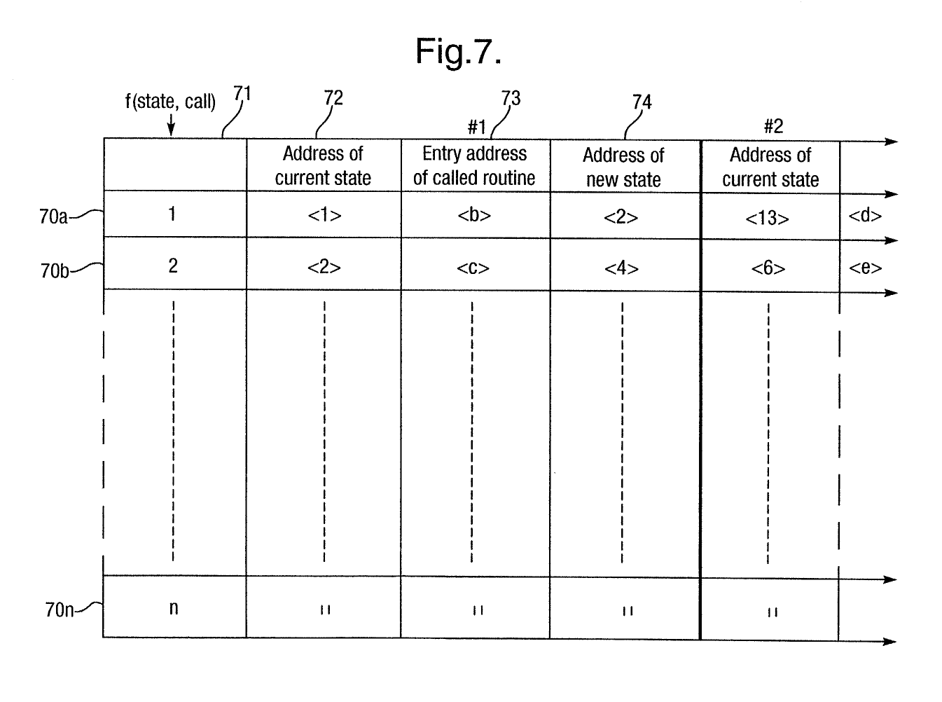

FIG. 7 illustrates the hash table of an embodiment of the invention;

FIG. 8 illustrates the state records of the finite state machine:

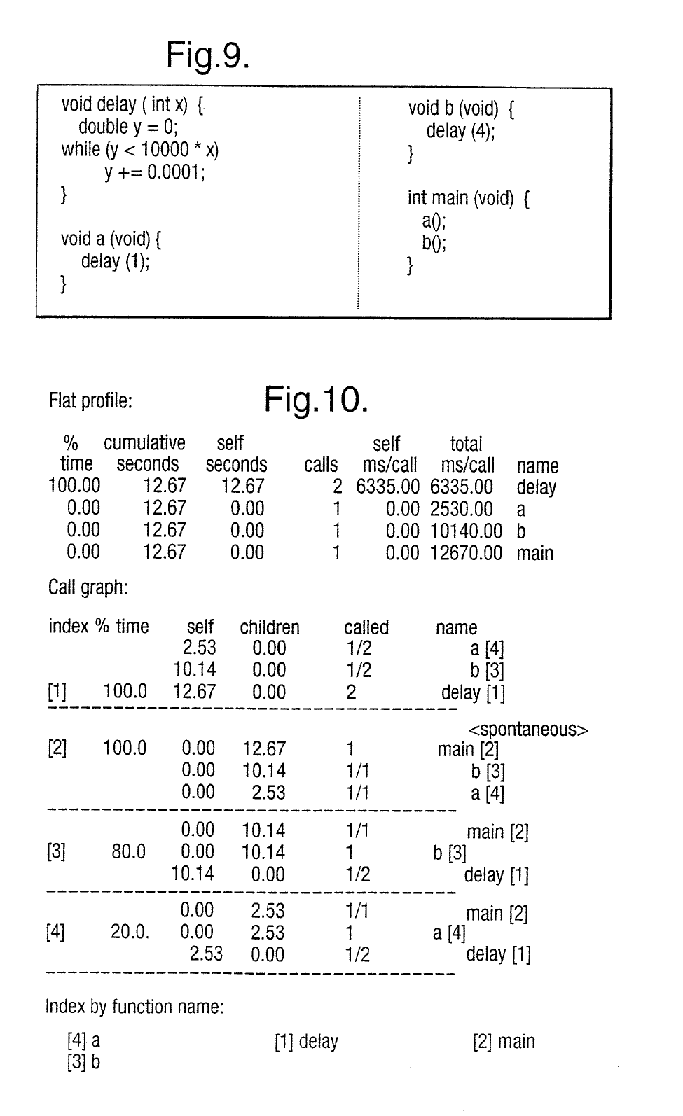

FIG. 9 is an example program for profiling;

FIG. 10 illustrates the profile statistics for the program of FIG. 9 obtained with an embodiment of the invention; and

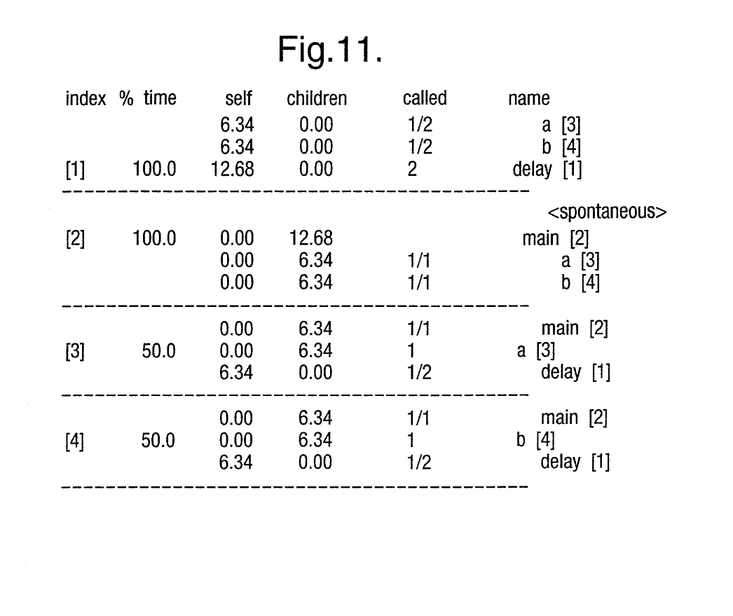

FIG. 11 illustrates a call-graph for the program of FIG. 9 obtained with the prior art gprof profiler.

FIG. 1 illustrates a simple program and its corresponding call-graph. It can be seen from FIG. 1 that there is a routine called “main” which calls subroutines a, b, max and c. There is an additional routine called “sig” which has no ancestors or descendents. The aim of a profiler producing a dynamic call-graph is to record only the routines and arcs which are traversed during an execution of the profiled program. In order to profile a program, the code of the program must be “instrumented” which means including calls to profiling routines at the beginning and end of each subroutine in the program. In the present invention these calls result in the construction of the data structure as explained below which record the call-graph of the program as a series of states of a finite state machine, and the time spent in each state. In the embodiment of the invention mentioned below, the program being profiled is instrumented using instrumenting subroutines offered by the GNU, Gcc compiler, which is readily available.

In accordance with the present invention the profiler constructs, during execution of the program being analysed, a finite state machine. Each state in the state machine corresponds to a set of execution contexts for the program, and each transition between states represents the change in execution context which takes place at a subroutine call, and is labelled with the identity of the subroutine being called.

With this embodiment of the present invention, the time spent in each state of the finite state machine is recorded in a state record together with other information about that state. Thus the finite state machine is constructed dynamically during execution of the program in that during execution of the profiled program, the first time a distinct call sequence of subroutines arises, the corresponding state is created and added to the state machine. When the same configuration arises again later, the profiler simply follows the state transition of the machine and continues to accumulate the time in that state. At the end of the execution the information needed for profiling is contained in the state records. Then in an analysis phase following execution of the program, the information in the state records is used to construct the profile by, inter alia, charging the time in each state to the subroutines which constitute that state.

FIG. 2 shows a small C program along with the state machine that is created in accordance with an embodiment of the invention (execution time not shown), if all subroutines are monitored during execution. The program corresponds to the call sequence scenario

1. main
2. main → a
3. main → a → b
4. main → a → b → c
5. main → b → c
6. main → a
7. main → a → b

The initial state S1 is created when main is called in sequence 1. Call sequences 2-5 are all unique, creating new states and state transitions for each of them (states S2-S5). But when main calls a again in the sixth call sequence, the corresponding states S2 already exists and is returned by the transition subroutine. It then becomes the new active state, and its call counter (“count”) is simply incremented by one. Similarly, the subsequent call to b in sequence 7 causes the state S3 to be reactivated and its counter increased.

As illustrated in FIG. 2, each state of the state machine records the call sequence, the currently active subroutine, a count of the number of times that state has been entered, and the cumulative time in that state (though the timings are not entered in FIG. 2). It will be appreciated that when a program is being analysed, on the initial start-up of the program the number of states increases very quickly, but the rate of creation reduces in time as the program tends later to be re-entering states already existing in the state machine.

In this embodiment of the present invention, the transition function of the state machine is represented by a hash table as illustrated in FIG. 3 and in more detail in FIG. 7. On calling of a subroutine, the address of the current state record is hashed with the address of the subroutine being called to provide a key, which is an address in the hash table. In one embodiment of the invention, the hashing function is a simple shift of the two bit patterns, together with an XOR operation. However, different hashing functions are possible. The entry in the hash table found at the address given by the key records the resulting state into which the state machine passes. The hash table is illustrated in more detail in FIG. 7 in which the first column 71 represents the addresses or keys produced by hashing the address of the current state and the address of the called subroutine, the second and third columns 72, 73 record the address of the current state and of the called subroutine and the fourth column 74 records the address of the resulting state into which the state machine is to pass. If a hash of the current state address and address of the called subroutine reaches a blank entry in the hash table, it means that the state machine is passing into a new state, not yet seen. When this happens a new state record is created for the new state, and a new entry is made in the hash table of the address of that new state record.

Hash tables can be constructed so that collisions (ie. where the hash of two different combinations of current state and called subroutine arrive at the same place) do not occur. However, in this embodiment, collisions are allowed to occur, which means that each entry 70a, 70b . . . 70n, in the hash table may store several possible transitions labelled #1 and #2 in FIG. 7. These records are simply daisy-chained in the table and the correct one can be picked by reference to the current state or called subroutine.

Thus in FIG. 7 the start of a second transition record is shown in entry 70a which is as a result of a call of routine “d” from state “13”, the result of hashing these giving the same key as a hash of state “1” and routine “b”.

The profiling mechanism of this embodiment also maintains a stack which shadows the subroutine stack of the running program. This makes returning to the previous state on a return from a subroutine very fast. The shadow stack is illustrated in FIG. 6. It can be seen that the top of the shadow stack simply stores the address of the current state (the current state record), with its predecessors beneath it. When a new state is entered, the address of the new state is put on top of the stack. On a return the stack is popped, giving the previous state of the machine. Thus each item in the stack is a state of the finite state machine, represented by a pointer to the relevant state record.

The data recorded for each state of the state machine is illustrated in the table of FIG. 8. Each state records the call sequence 82, namely the set of active subroutines on the subroutine stack (or the sequence of active arcs), the currently active subroutine 83, the cumulative time in this state 84, the count of the number of entries to this state 85, and optionally, the self-recursion count 86. The set of active subroutines or sequence of active arcs may be recorded in a variety of compacted ways as discussed later.

The cumulative time in each state is recorded at each change of state, whether caused by subroutine call or return, by adding the time elapsed since the last change of state to the time of the current state. The timing can be achieved by any of the currently known techniques, such as using a hardware cycle counter which keeps an accurate count of every cycle that occurs on the processor, adding counters to each block of the program being profiled, or using a timer which delivers a profiling signal to the processor at regular intervals.

In a program which terminates (ie. ends) the number of different configurations of active subroutines that can arise is finite, but can be very large. It is unlikely that every subroutine in a program calls every other subroutine in the program, but in typically recursive programs, however, each subroutine can appear several times on the call stack, and the number of possible states is therefore only bounded by the maximum depth of the call stack and the virtual memory available. It is advantageous, therefore, to find ways to reduce the number of states generated in a recursive program. Two types of recursion occur, direct recursion when a subroutine calls itself and indirect recursion when a subroutine is called again by one of its descendents.

FIG. 5 illustrates the state of the finite state machine of this embodiment in the presence of direct recursion. FIG. 5 illustrates a state in which the active subroutine is c, having been preceded by routines, main, a and b, and in which the “count”, ie. the number of times that state has been entered is 1. An additional counter is present, labelled “self” in FIG. 5, and indicated in line 86 in FIG. 8 which records the number of times the subroutine calls itself. In FIG. 5 it is illustrated as having called itself twice. Thus as illustrated in FIG. 5 in the case of direct recursion, the state of the finite state machine does not change. Further, it is not necessary to update the time counter for the current state; this can be delayed until the next subroutine call or return. The self counter therefore is simply presenting additional information in the subsequent call-graph profile, which may be useful to the programmer, but it does not affect the way the time is charged to the ancestors of the current subroutine.

In the case of indirect (or mutual) recursion, there are several different ways of reducing the number of states required of the state machine. All of them use the idea of removing information which is not needed in the analysis phase to condense the call sequence, and looking for an existing state which corresponds to the condensed call sequence (ie. has the same arc list and the same currently active subroutine). If such a matching state is found, then that state can simply be reused by adding a new transition from the current state to that existing state to the transition table of the machine. In order to be able to create accurately a call-graph from a condensed list, the following properties are required:

1. It must be possible to distribute the active subroutine's execution time as children time to all its ancestors, but to avoid double-counting in which time is charged to itself where it is its own ancestor.

2. The execution time is to be charged to the outgoing arc of the most recent invocation of each subroutine in the call sequence, and enough information must be kept to create a call-graph for the program.

The first and most simple way of keeping a condensed list is to retain only the most recent activation of a subroutine. Thus in the calling sequence: main, a, b, a, the sequence could be reduced to: main, b, a. So a state [main, a, b, a] would not be created, instead it would be regarded as the same as the state [main, b, a] whose count is increased by one, and whose time is increased by the time the sequence main, a, b, a is active. This would ensure that a's execution time is distributed correctly as children time to its ancestors “b” and “main”. It also avoids charging, its time twice to itself. However, information that the arc main, a was present has been lost.

A more refined approach is to extend the state record to store the active subroutine and the sequence of active arcs. This sequence is reduced to record only the most recent outgoing arc of each subroutine in the list. This is done by searching for occurrences of the active subroutine among the parents in the list and removing them. In practice, there is at most one occurrence because each list is created by copying the list of the previous state and adding just the new arc from the current active subroutine to the one being called. The new active subroutine's execution time can, during the analysis phase, be distributed to the parent subroutine of each arc and to the arc itself and the arcs are used to create the program's dynamic call-graph as will be explained later.

Compacting the list of active arcs in this way means that, again, there may already be a state in the machine with the same active subroutine and same arc list which can be used instead of creating a new state. In order to search for such a state, for each subroutine a list of states for which that subroutine is the currently active subroutine is kept. This list is organised as a pointer-linked chain, using a pointer field in the record for each state. A separate hash table, with the subroutine address as the key, may be used to locate the head state of the list. Alternatively, the same hash table may be used as for finding transitions, with a null value for the part of the key corresponding to the current state. If a state with the same arc list does exist, then this is used as the next state in the machine. Otherwise a new state needs to be created. In both cases, a new transition is added to the transition hash table.

To illustrate this technique, consider the call sequence scenario below, and the corresponding state machine it would create, depicted in FIG. 4 (showing only active arcs above the active subroutine).

| | |
|---|---|
| 1. | main |
| 2. | main → a |
| 3. | main → a → c |
| 4. | main → a → c → b |
| 5. | main → a → b |
| 6. | main → a → b → c |
| 7. | main → a → b → c → a |
| 8. | main → a → b → c → a → c |
| 9. | main → a → b → c → a → c → b |

The first six call sequences contain no recursive calls, and the corresponding states are created when no matching arc lists can be found in the machine. In the seventh call sequence, an indirect recursive call is made by a calling itself. Then when the state S7 is subsequently created, its arc list is constructed by copying the arc list of the current state S6, and the new arc c→a is added to the list, leaving the arcs

{main→a, a→b, b→c, c→a} (2.1)

Because a is the active subroutine, the arc a→b can be removed, thus reducing the list of arcs as shown in state S7 to

{main→a, b→c, c→a} (2.2)

Similarly, the recursive call to c in the eighth sequence removes the arc c→a from state S8. Then a new recursive call is made by b in sequence 9, the arc b→c is removed, and the new arc list is

{main→a, a→c, c→b} (2.3)

Searching the states in the machine where b is active (states S4 and S5 ), we find a matching arc list in state S4. This existing state then becomes the new active states by adding the following transition to the transition hash table:

(state S8, subroutine b)→state S4 (2.4)

Because each subroutine can appear only once as a parent in the compact arc list, and there is a finite number of subroutines, the number of possible states is bounded. This ensures that a finite-state machine is created even when the profiled program contains recursion. In practice, the number of states created is much smaller than the theoretical maximum number of different sets of subroutines.

In a further refinement each state may record the most recent activation of each currently active subroutine, together with the outgoing arc by which it has called another subroutine. This information may be economically represented by storing the list of most recent activations and ensuring that each is followed in the list by a record of the subroutine it has called. If this called subroutine would otherwise be dropped from the list because it is not the most recent activation of that subroutine, then it is retained for the purpose of representing an arc and marked specially. In the preferred embodiment, subroutines are represented by their entry addresses, and if these addresses do not occupy all available bits in the machine word, then the mark may conveniently be represented using one of the spare bits, either at the most-significant end of the word or (if subroutines are aligned in memory) at the least-significant end.

Optionally, further marked activations of subroutines may be added to the list of activations so that the arc incoming to each unmarked activation is recorded as well as the arc outgoing from it. Thus, in the example above, if only the most recent actuation of each state is recorded, together with the routine it calls, state S9, which in full is m, a, b, c, a, c, b would become m, (a), a, c, b. If incoming arcs are recorded as well as outgoing arcs, it would become m, (a), (c), a, c, b. The parenthesis indicates that the subroutine would be marked. The same state describes any call stack of the form m, [a, b, c]ⁿ, a, c, b.

The above describes the data structures which are formed during the execution of the program being profiled. It will be appreciated from this that the state machine is constructed dynamically, the data needed for profiling being stored in the state records. The shadow stack and hash tables are used only for the functioning of the state machine, during running of the program being analysed. Therefore after the program has terminated, the information in the state records must be analysed to produce the desired type of profile.

The state records contain all the necessary data needed to create a dynamic call-graph for a particular program execution. However, the subroutines are represented only by the address of their point of entry. In order to display the routine names symbolically, the routine addresses need mapping to their corresponding names. This is accomplished by reading the executable image's symbol table, and then constructing a table of subroutine addresses with their symbolic names. The list of subroutines will also represent the nodes in the call-graph, and so this is called the node list.

In addition to the subroutine address and symbolic name, each node also has to contain attributes to hold the total time spent in the subroutine, how many times it was called, the number of self recursive calls, a list of arcs to parents and children etc. The complete contents of the node data structure are given below:

address: The address of the subroutine's entry point.

name: The subroutine's symbolic name.

self time: The total time spent executing the subroutine.

child time: The total time spent executing all of the subroutine's descendents.

calls: The total number of calls made to the subroutine by other subroutines.

self calls: The total number of times the subroutine called itself (direct recursive calls).

index: An index number used to identify the subroutine when displaying a textual representation of the call graph.

parents: A list of arcs to the subroutine's parent nodes.

children: A list of arcs to the subroutine's child nodes.

The arcs in the call graph show the relationship between parent routines and child routines. In order to be able to display how many times each arc has been traversed and the time spent doing so two time values are associated with each arc. The first value is how much time the child (destination routine) spent in calls directly from the parent (source routine); the second value is how much time the child's descendents spent as the more remote descendents of the parent. The complete contents of the arc data structure in the node list are listed below:

parent: The source node (routine) of the arc.

child: The destination node (routine) of the arc.

calls: The number of calls from the parent to the child.

self time: The total time spent in the child when called by the parent.

child time: The total time spent in the child's descendents on behalf of the parent.

next parent: The next parent arc in the list of arcs for this child.

next child: The next child arc in the list of arcs for this parent.

In the analysis phase the data from the state records is then distributed to the node and arc data structures as follows. For each state recorded in the output file from the state machine, the state's active subroutine address is used to locate the corresponding node in the node list. The time and frequency counts are then distributed as follows:

The execution time accumulated in the state is added to the node's self time value to calculate the total time spent in the subroutine.

The number of times the state was activated is added to the node's calls attribute to give the total number of times a subroutine has been executed. Similarly, the node's self calls attribute is updated with the number of times the state was activated by direct recursive calls.

For each of the call arcs recorded in a state record, the parent (source) and child (destination) nodes of the arc are located in the arc data structure. The parent node's next child list is then searched to determine whether an arc between the two nodes already exists. If not, a new arc is created and attached to the parent node's next child list and the child node's next parent list, thus recording both incoming and outgoing arcs for each node. The arcs are attributed differently depending on how they are related to the state's active subroutine:

For the most recent arc in the state, the entry count for the state is added to the call counter for the arc so as to measure the number of times the arc was traversed during execution.

If the destination of an arc is the same as the active function, the state's execution time is charged to the arc as self time.

For all other call arcs in the state, the state's execution time is simply charged to the arc as child time, to reflect how much time the state's active subroutine spent as a descendent of the arc's source routine.

After a single pass over the state records stored on file, the complete accurate dynamic call-graph is created in memory. No further processing, cycle detection or frequency count distribution is necessary, other than for presentation purposes (eg. sorting the nodes by time). Some of the nodes in the node list might have zero call counts, which indicates that the subroutines were not called during execution or were not compiled for profiling. Such subroutines may be skipped during presentation of the profile statistics.

In order to present this data to the programmer, both a flat profile and a call-graph profile can be produced. The flat profile is easily obtained from the data in memory by traversing and printing the relevant attributes of each node in the node list. FIG. 10 illustrates a flat profile for the simple program illustrated in FIG. 9. In the program illustrated in FIG. 9 routine “main” calls the subroutines “a” and “b” which in turn both call the subroutine “delay”. The program is designed to illustrate the advantages of the profile of the invention because the arguments passed to the routine “delay” cause it to run four times longer when it is called from routine “b” than when it is called from routine “a”.

FIG. 10 illustrates the profiles produced by the embodiment above. While, for ease of understanding, these are designed to resemble the output of gprof, other forms of output are possible, including (a) interactive presentation of the data, and (b) presentations that depict chains of dependency longer than a single arc in the call-graph.

Referring to FIG. 10, from the flat profile, it can be seen that all of the accumulated execution time is spent in the “delay” routine. The fraction of time spent in the other routines is too small to be detected between two samples of the interval timer.

The subroutines in the flat profile are sorted by decreasing order of execution time, by decreasing number of times they are called, and finally alphabetically by name. The columns store the information as follows:

% time: Percentage of the total execution time spent in this subroutine.

Cumulative seconds: The total number of seconds spent in this subroutine plus the time spent in all subroutines preceding this one in the list.

Self seconds: The total number of seconds spent executing this subroutine.

Calls: The number of times this subroutine was called, direct recursive calls not included.

Self/ms/call: The average number of milliseconds spent for each invocation of this subroutine.

Total ms/call: The average number of milliseconds spent in this subroutine and all its descendents.

Name: The symbolic name of this subroutine.

The flat profile can be useful for identifying quickly the subroutines that dominate the execution time, and suggest that the programmer should focus his/her efforts in tuning those subroutines. Even small modifications in such routines may have a great effect on the overall execution time.

FIG. 10 also illustrates the call-graph profile.

The call-graph profile listing is a textual representation of the call-graph. Each subroutine is listed together with its direct parents and children. The table is divided into entries, separated by a line of dashes, with one entry for each subroutine in the flat profile. Each entry contains one or more lines, and describes the given subroutine and its relationship to its parents and children.

To make it easy to tell which subroutine the entry is for, the particular subroutine name is shifted further to the left than the other names. The subroutine's parents are listed above the subroutine, and its children are listed below the subroutine. The entries in the table are sorted by the total amount of time spent in each routine and its children. The internal profiling routines and the time spent in them are excluded and never mentioned in the call-graph.

The following describes each of the columns in the table, which have different meanings for the subroutine itself, for its parents and for its children:

index: Subroutine entries are associated with unique consecutive integer numbers, which can be used as a cross-reference when looking for the subroutine elsewhere in the call-graph.

% time: This is the percentage of the total execution time which is spent in the subroutine and all its children.

self: For the subroutine itself, the self time is the total amount of time spent executing the subroutine, which is equal to the subroutine's self seconds filled in the flat profile. For each of the subroutine's parents, the self time shows the total amount of time the subroutine spent when it was called from the given parent. For each of the subroutine's children, the self time shows how much time was spent executing each child when they were called from the subroutine.

children: For the subroutine itself, this column shows the total amount of time spent in calls to all of its children. For each of the subroutine's parents, the children column shows how much time was spent in the subroutine's children when the subroutine was called from the given parent. For each of the subroutine's children, the children columns shows how much time was spent in the child's decendents when the listed child was called from the subroutine.

called: For the subroutine itself, the called figure can include two numbers. The first is always the number of times the subroutine was invoked by other subroutines. If the subroutine called itself, a “+” is appended and followed by the number of direct recursive calls the subroutine made. For the subroutine's parents and children, the children column includes two numbers, displayed as m/n. For the parents, this means that of the n calls the parent made to the subroutine, m of those calls came from the given parent. For the children, the number means that of the n non-recursive calls to the given child, m of those calls came from this subroutine.

name: This column is the name of the subroutine to which this line applies, followed by its index number.

As with the flat profile, the analysis program transverses the node list (sorted by the routine's combined self and child time) to print the call-graph table entires, skipping subroutines with zero call counts. The attached parents and children arc lists are used to display the parent and children statistics for each routine. The call graph listing is followed by a list of all the subroutines and their corresponding index numbers for easy reference to the table.

Referring to the call-graph in FIG. 10, the first entry in the call-graph profile indicates that of the total 12.67 seconds spent in delay, 2.53 seconds was spent running as a child of a, while 10.14 seconds was spent running as a child of b. In addition, the third and fourth entry indicate that 80% of the total execution time was caused by b and its children, while the corresponding number for a is 20%.

For reference, the same program was profiled with the prior art gprof profiler and the result is shown in FIG. 11. Because gprof relies on the average time assumption, the total execution time of 12.68 seconds is incorrectly distributed equally as 6.34 seconds to each of delays parents a and b. This also shows in the third and fourth entry of the call-graph where both a and b are listed inaccurately with 50% of the total execution time.

In the absence of mutual recursion, the times recorded in each entry of the call-graph profile satisfy certain algebraic relationships. The subroutine's self time is equal to the sum of the self times shown for incoming arcs to the subroutine, and its child time is equal both to the sum of the child times shown for incoming arcs and to the sum of the self and child times together shown for outgoing arcs.

If mutual recursion occurs, then these relationships may no longer be satisfied. The sum of the self times shown for incoming arcs may be larger than the self time shown for the subroutine itself, because time spent in a subroutine is charged as self time to each arc in the state that leads to an activation of the subroutine, and in the case of mutual recursion, there may be more than one of these. Also, the sum of the child times shown for incoming arcs may be less than the child time shown for the subroutine itself, because time spent in mutually recursive calls of parent subroutines is not recharged to them as child time.

The relationships are re-established by the optional extension to the method, in which the incoming as well as the outgoing arc of each active subroutine is recorded in the state. During the analysis phase, each arc is associated with two sets of self and child times, one set for the source of the arc considered as a parent of its destination, and the other set for the destination considered as a child of its source. In charging time spent in the state to its constituent arcs, the time is added to the first set of times for each outgoing arc from an activation that is part of the state, and to the second set of times for each incoming arc of such activations. When an arc leads from one activation to another, both part of the state, then the time is charged to both sets.

In displaying the results as a call-graph profile, it is the first set of times for each arc that is shown for the children of each subroutine, and the second set of times for the parents of each subroutine. In the case of mutual recursion, the two sets of times will differ, so that the line shown for the child in the entry for the parent will differ from the line shown for the parent in the entry for the child, but in both cases the values shown will be a true representation of the proportion in which execution time is divided among parents and children.

It should be appreciated, therefore, that by the dynamic construction of the state machine to record the execution context of subroutines during run time profiling of a computer program, a significant amount of information about the program can be recorded easily, quickly and accurately during the execution phase. The information in the state records of the state machine can then be used in the analysis phase to produce call-graph profiles which accurately deal with such problems as direct and mutual recursion and also indicate the correct sequence of subroutine calls.

This profiler may be implemented with the Gnu C compiler which includes a flag which inserts calls to specified monitoring routines at both the entry and exit of each subroutine. These monitoring routines receive as arguments the entry addresses of the calling and called subroutines. These addresses are sufficient to identify the subroutines in the profiler as explained above.

1. A method of profiling the execution of a computer program comprising subroutines, the method comprising recording the identity of each called subroutine and its execution time, and wherein the execution context is recorded in the states of a finite state machine.

2. A method according to claim 1, wherein the finite state machine is constructed during execution of the computer program being profiled.

3. A method according to claims 1 or 2, wherein the states of the finite state machine represent the call-graph of the computer program being profiled.

4. A method according to claim 1, 2 or 3, wherein the execution context is recorded by recording the identity of each active subroutine.

5. A method according to claim 4, further comprising recording in the execution context the number of times a subroutine calls itself directly.

6. A method according to any one of the preceding claims further comprising removing from the recorded execution context all but the most recent invocation of each subroutine.

7. A method according to any one of the preceding claims further comprising recording in the execution context the most recent invocation of each subroutine of the active set of subroutines, and the source or destination respectively of each incoming and outgoing arc to or from the recorded invocation.

8. A method according to claim 7, wherein the source or destination respectively are recorded by recording the identity of the subroutine which is the source or destination, together with a flag indicating that it represents an arc.

9. A method according to any one of the preceding claims, wherein the identity of a subroutine is recorded by recording the entry address of the subroutine.

10. A method according to any one of the preceding claims, wherein the transition function of the finite state machine is represented by a hash table indexed by the current state of the finite state machine and the entry address of the subroutine being called.

11. A method according to any one of the preceding claims, wherein each state of the finite state machine comprises a state record recording the identity of the currently active subroutine, its execution time and the execution context.

12. A method according to claim 11, wherein each state record includes a counter for counting the number of times the currently active subroutine calls itself directly.

13. A method according to claim 11 or 12, wherein each state record includes a counter for counting the number of times that each state is entered.

14. A method according to claim 11, 12 or 13, wherein each state record records an arc list recording the sequence of active calls leading to the currently active subroutine.

15. A method according to claim 14, further comprising removing from the arc list those arcs which have as a source the currently active subroutine, to produce a compact arc list.

16. A method according to claim 15, further comprising comparing the compact arc list with the arc list of other state records of states with the same currently active subroutine, and in the event of a match recording a transition from the current state to the matching state.

17. A method according to claim 16 further comprising the step, in the event of no match being found, establishing a new state of the finite state machine recording the currently active subroutine and the arc list.

18. A method according to any one of claims 14 to 17 wherein the arc list is represented by a list of the most recent activation of each subroutine.

19. A method according to claim 18 wherein the arc list records also the identity of the subroutine which each subroutine in the list calls where that called subroutine is not the most recent activation of that subroutine.

20. A method according to claim 18 or 19 wherein the arc list records also the identity of the subroutine which calls each subroutine in the list where the calling subroutine is not the most recent activation of that subroutine.

21. A method according to claim 19 or 20 wherein said identity is recorded in a way distinguishable from the most recent activation to signify that it represents the source or destination of an arc.

22. A method according to any one of claims 11 to 21, further comprising maintaining a shadow stack whose entries represent the successive sets of currently active subroutines, the shadow stack being popped on a return from a subroutine.

23. A method according to claim 22, wherein the entries on the shadow stack record the address of the current state record.

24. A method of profiling the execution of a computer program comprising subroutines, the method being substantially as hereinbefore described with reference to and as illustrated in the accompanying drawings.

25. A computer program comprising program code means for executing on a programmed computer system the method of any one of the preceding claims.
